(19) United States
(12) Patent Application Publication
(10) Pub. No.: US 2003/0105848 A1
(43) Pub. Date: Jun. 5, 2003

(54) Method and apparatus for displaying network data

(76) Inventor: Steven G. Henry, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/998,795

(22) Filed: Dec. 3, 2001

(51) Int. Cl. G06F 15/173; G09G 5/00

(52) U.S. Cl. 709/223; 345/734

(57) ABSTRACT

Apparatus and methods for displaying network data with an appliance that is operatively associated with a network are disclosed. According to one embodiment, the method may comprise the steps of receiving network data at an appliance that is operatively associated with a network from another device connected to the network, and displaying at least a portion of the network data on electronic display apparatus that is operatively associated with the appliance and that allows for user interaction with and operation of the appliance. Electronically displaying data is not a primary function of the appliance.

### FIELD OF INVENTION

The invention relates generally to appliances, and more specifically, to a method and apparatus for displaying network data.

### BACKGROUND

Individuals and businesses both depend on reliable communication with others. As a result, various modes of communication have been developed and continue to be developed and enhanced. For example, email is becoming an ever increasingly popular method of communicating using personal computers (PCs), and more recently, using stand-alone email appliances. Additional modes of communication include, by way of example, facsimile or fax, Internet “web” pages, file transfer protocol (FTP), among others.

Individual appliances are available for separate modes of communication. For example, fax machines are available for sending and receiving faxes, and email appliances are available for sending and receiving email. However, some individuals or even businesses may not have access to the devices required for one or more of these communication modes. For example, a businessperson may not have access to a fax machine outside of the office, but may have access to an email account. In addition, purchasing individual appliances for each mode of communication may be expensive and space consuming, which may be particularly burdensome for individuals and small or home-based businesses.

Devices that consolidate various functions are becoming increasingly popular. For example, some photocopiers may also be used as network printers and/or fax machines. Likewise, a conventional personal computer (PC) may be used for communicating, among other more traditional functions. For example, a conventional PC may be used to send and receive faxes and email, to upload and download files from a network (e.g., the Internet, an Intranet, etc.), and even for voice communications using Internet Protocol (IP) telephony. However, learning to use the software (e.g., fax software, etc.) and the hardware peripherals (e.g., a flatbed scanner, etc.) required to successfully communicate using the PC, may be a daunting task, especially for those unfamiliar with PCs. In addition, purchasing a PC and the necessary software and hardware peripherals may be relatively expensive, especially where only limited use is made of the more traditional functions of the PC (e.g., where it is used primarily for sending and receiving email and faxes, etc.).

Alternatively, multifunction peripherals (MFPs) offer a variety of communication modes from an individual stand-alone appliance. Multifunction peripherals typically may be used to scan paper documents and then transmit the scanned image to one of a variety of communication devices, including but not limited to a fax machine, an email account, another MFP, a printer, a computer (e.g., for storage, viewing, editing, etc.), etc. Although not limited in use, multifunction peripherals are especially useful in home offices or field offices. For example, closing agents typically close real estate transactions for title companies at various field offices. The closing agent may need to send a copy of a document to the main office of the title company for approval before completing the transaction. As such, the closing agent may position the document or documents in the automatic document feeder (ADF), or directly on the scanning bed of the multifunction peripheral. With a few steps (e.g., entering the recipient's fax number, etc.), the document is scanned and transmitted to the fax machine at the main office. Or for example, where the title company officer whose approval is required only has access to an email account, the multifunction device may instead send the document to the title company officer's email account.

To accomplish tasks such as those just described, many devices are network-ready or network-capable and are thus capable of being connected or linked to a network. Indeed, each day, more individuals and businesses are using various devices to access the Internet.

### SUMMARY OF THE INVENTION

Methods for displaying network data are disclosed. According to one embodiment, the method may comprise the steps of receiving network data at an appliance that is operatively associated with a network from another device connected to the network, and displaying at least a portion of the network data on electronic display apparatus that is operatively associated with the appliance and that allows for user interaction with and operation of the appliance. Electronically displaying data is not a primary function of the appliance.

Also disclosed are apparatus and systems for displaying network data. According to one embodiment, the apparatus may comprise one or more computer readable storage media and computer readable program code stored thereon. The computer readable program code may comprise program code for receiving network data at an appliance that is operatively associated with a network from another device connected to a network and program code for displaying at least a portion of the network data on electronic display apparatus that is operatively associated with the appliance and that allows for user interaction with and operation of the appliance. Electronically displaying data is not a primary function of the appliance.

### BRIEF DESCRIPTION OF THE DRAWING

Illustrative and presently preferred embodiments of the invention are shown in the accompanying drawing in which:

FIG. 1 is a high level diagram illustrating an embodiment of a system that may be used for displaying network data;

FIG. 2 illustrates the relationship between FIGS. 2A and 2B; and

FIGS. 2A and 2B form a flow chart illustrating an embodiment of a method that may be used to display network data.

### DETAILED DESCRIPTION OF THE INVENTION

An apparatus 10 and a method 12 for displaying at least a portion 14 of network data 16 (e.g., textual and/or graphical data in the form of advertisements, public service announcements, etc.) are shown and described herein as they could be used with an appliance 18. Briefly, the invention generally comprises providing network data 16 from a network site 20 to the appliance 18, and then displaying at least a portion 14 of the network data 16 on an electronic or digital display apparatus (e.g., a display panel 22) operatively associated with the appliance 18.

One advantage that may be realized by an embodiment of the invention is that it allows appliances, such as those already contained in many homes, businesses, etc., to display network data (e.g., textual and/or graphical network data in the form of advertisements, public service announcements, etc.) acquired over a network. In doing so, the present invention may increase the utility of an appliance and may also allow for the realization of proprietary or monetary gains. For example, in one embodiment, the at least a portion 14 of the network data 16 may comprise advertisements from companies that have paid a fee for the right to have their advertisements displayed.

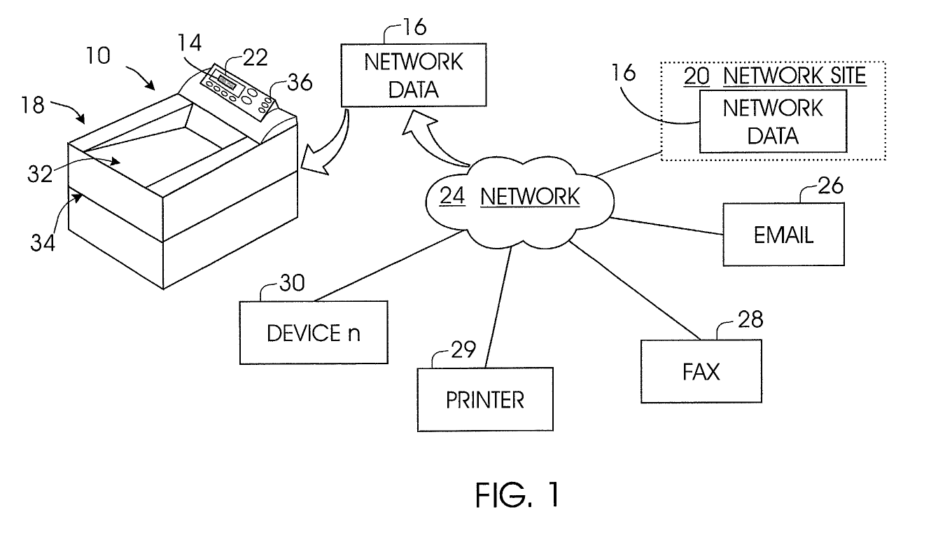

Another advantage that may be realized by an embodiment of the invention is that it may not require any hardware changes to the appliance itself since the apparatus 10 may comprise computer readable program code that need not be stored within the appliance itself. As explained later, the apparatus 10 may comprise computer readable program code stored in one or more suitable computer readable storage media residing at, or associated with, the appliance 18, the network site 20, the network device 30, elsewhere on the network 24, a combination thereof, etc. See FIG. 1. Indeed, the computer readable program code may also reside within a “hard wired” box or stand-alone device (not shown) that is operatively associated with the network 24 and the appliance 18.

Yet another advantage that may be realized by an embodiment of the invention is that it may be used in conjunction with any of a wide range of appliances, such a digital senders, scanners, printers, multifunction peripherals, multifunction devices, etc.

Still yet another advantage that may be realized by an embodiment of the invention is that, as explained later, it should not interfere with the regular course of operation for the appliance 18. For example, when the appliance 18 is in an active mode, the network site 20 may stop sending the network data 16 to the appliance 18, the appliance 18 may refuse to or simply not receive the network data 16 sent from the network site 20, and/or the appliance 18 may receive the network data 16 but not display the at least a portion 14 thereof until the appliance 18 is back in an inactive or idle mode.

Having generally described the apparatus 10 and method 12 for displaying network data with an appliance, as well as some of their more significant features and advantages, various embodiments of the apparatus 10 and method 12 will now be described in detail.

An exemplary network 24 in which the apparatus 10 may be used and thus over which the network data 16 may be provided to the appliance 18 is shown in FIG. 1. Preferably, the network 24 comprises the Internet. However, it is to be understood that the network 24 may be any suitable network (e.g., a local area network (LAN), a wide area network (WAN), an Intranet, the Internet, a combination thereof, etc.). Likewise, any number (i.e., one or more) of network destinations and devices may be operatively associated with or linked to the network 24 (e.g., appliance 18, network site 20, email address or account 26, facsimile machine 28, printer 29, device 30, a personal computer (PC), a copier, etc.) via any suitable means (e.g., modem, T-1, T-3, digital subscriber line (DSL), infrared, satellite, cable, etc.), including through other devices (e.g., routers, hubs, etc.), through other networks (e.g., LAN, WAN, Intranet, the Internet, etc.), etc.

To acquire the network data 16 over the network 24 and display the at least a portion 14 thereof, the appliance 18 may be used in conjunction with the apparatus 10. The appliance 18 may have a paper-handling function associated therewith. For example, the appliance 18 may include a scanner apparatus that may be used to scan one or more documents and convert them to electronic format. In addition to, or alternatively, the appliance 18 may include a printer apparatus that may be used to print out hard copies of one or more documents.

In one embodiment, the appliance 18 may comprise a digital sender or a multifunction peripheral (MFP), either of which may be used as follows to send a paper document (not shown) over the network 24. First, a user may position the paper document in an automatic document feeder (ADF) 32 or directly on a scanning bed 34 of the appliance 18. If the paper document is placed within the ADF 32, a sensor (not shown), such as an optical sensor, may be located in the ADF 32 and may sense that the paper document has been positioned in the ADF 32. Next, the user may activate the appliance 18, for example, by pressing a scan key (e.g., 36). As a result, the appliance 18 may scan the paper document. The user may then identify a recipient for the scanned image of the paper document. For example, the user may identify a recipient by keying in a fax number, email address, etc., using the keypad 36 or by selecting the same from a menu shown on the display panel 22 of the appliance 18. Finally, the appliance 18 may send the scanned image of the document via the network 24 to the recipient previously identified or selected by the user.

It is understood that the term “paper document” as used herein is intended to encompass any document or portion thereof (e.g., photocopies, printed paper, photographs, slides, transparencies, viewgraphs, color documents, black/white documents, etc.) that may be imaged by the appliance 18 and then sent over the network 24 to a network destination (e.g., network site 20, email account 26, fax machine 28, printer 29, device 30, etc.).

More specifically, in one embodiment, the appliance 18 comprises an HP® 9100C Digital Sender™, which is currently available from Hewlett-Packard® Company, Palo Alto, Calif. The HP® 9100C Digital Sender™ is an appliance that is capable of scanning documents and then converting the documents to electronic format, such as Portable Document Format (PDF) and Tagged Image File Format (TIFF). The HP® 9100C Digital Sender™ is enabled for sending electronic documents to email accounts, fax machines, to PCs (e.g., for viewing or editing with suitable software applications), to HP® JetSend®-enabled devices, to applications, and to network printers. In another embodiment, the appliance 18 may comprise an HP® OfficeJet® G95 multifunction peripheral, which is also currently available from Hewlett-Packard® Company, Palo Alto, Calif. The HP® OfficeJet® G95 multifunction peripheral is an appliance that is capable of printing, copying, faxing, and scanning documents, and thus may be used to print the at least a portion 14 of the network data 16. It should be noted, however, that any of a wide range of other suitable appliances 18, now known or later developed, might also be used in conjunction with the apparatus 10. Accordingly, the present invention should not be regarded as limited to use in conjunction with the appliance 18 shown and described herein.

Although the appliance 18 may assume a variety of forms and may be connected to the network 24 in a variety of manners (e.g., directly, via an intermediary PC, etc.), it should be noted that the appliance 18 is not a cellular phone, “general purpose” computer or a “personal” computer, such as a desktop computer, laptop computer, personal digital assistant (PDA), etc. Rather, the appliance 18 may comprise a specific-purpose(s), specific-function(s), or application-specific(s) device (e.g., peripheral, hardware device, other device, etc.). In other words, the appliance 18 may comprise a device that is dedicated to one or more specific purposes, functions, or applications. For example, in various embodiments of the invention, the appliance 18 may comprise any of a wide range of input and/or output devices, such as a digital capture input device (e.g., digital sender, multifunction peripheral, multifunction device, scanner, digital camera, etc.), a printer, a photocopier, a fax machine, etc.

It should also be noted that the appliance 18 itself is not a stand-alone electronic display apparatus either, such as a computer monitor, computer screen, television, etc. Stated differently, the appliance 18 is not a device having the primary or specific function(s) or purpose(s) of electronically displaying data and/or images.

Although the display apparatus (e.g., display panel 22) may be used to electronically display data (e.g., textual and/or graphical data), it should be noted that the electronic display apparatus is not a computer screen of a “general purpose” computer or “personal” computer, such as the display screen of a laptop computer or PDA. Rather, the electronic display apparatus may comprise the means through which a user may interface with the appliance 18. Stated differently, the electronic display apparatus of the appliance may allow a user to operate or access (e.g., use, determine status of, etc.) the appliance 18 and thus carry out the functionality of the appliance 18. For example, in the embodiment shown and described herein, the appliance 18 may comprise a digital sender capable of converting documents to electronic format and transmitting the converted electronic documents over the network 24. In such an embodiment, the electronic display apparatus may comprise the display panel 22, which may provide, among other things, the means through which a user may identify a recipient to which the appliance 18 will send the electronic documents (e.g., by selecting the recipient from a menu displayed via the display panel 22).

It is understood that although the appliance 18 is preferably enabled for connection to a Transmission Control Protocol/Internet Protocol (TCP/IP) network 24, the appliance 18 may be connected over any suitable network or networks, including but not limited to, a local area network (LAN), a wide area network (WAN), a secure network, an Intranet, the Internet, etc. Likewise, the appliance 18 may be connected to the network 24 in any suitable manner, including but not limited to, a hardwired connection, an infrared connection, a dial-up connection (i.e., using a modem), a dedicated connection (e.g., cable, digital subscriber line (DSL), T-1, T3), via BLUETOOTH™M, via satellite, through yet other devices (e.g., routers, hubs, etc.), through other networks (e.g., LAN, WAN, Intranet, the Internet, etc.), through a combination of networks, etc.

Moreover, although FIG. 1 shows the appliance 18 being directly connected to the network 24 (i.e., with no intermediary devices between the appliance 18 and the network 24), such need not be the case. For example, in an alternative embodiment (not shown), the appliance 18 may be linked to the network 24 via one or more intermediary devices, such as a personal computer.

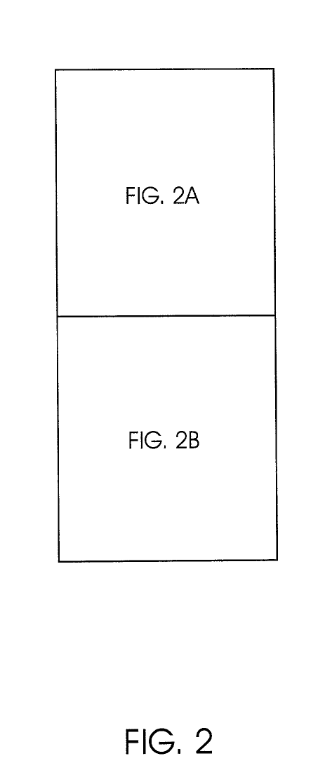

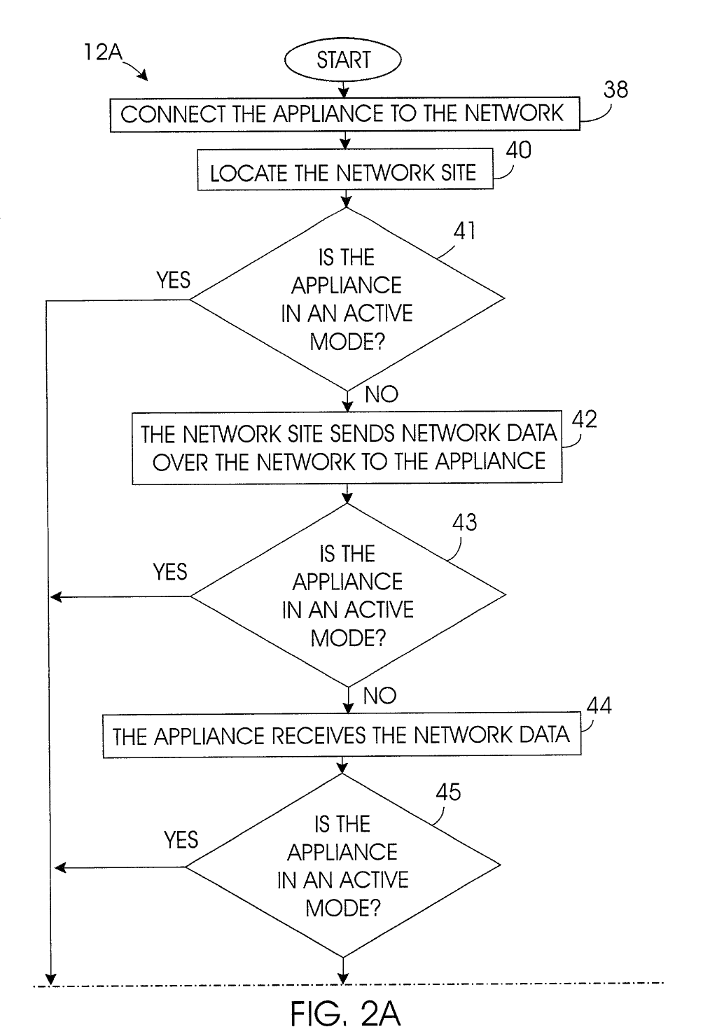

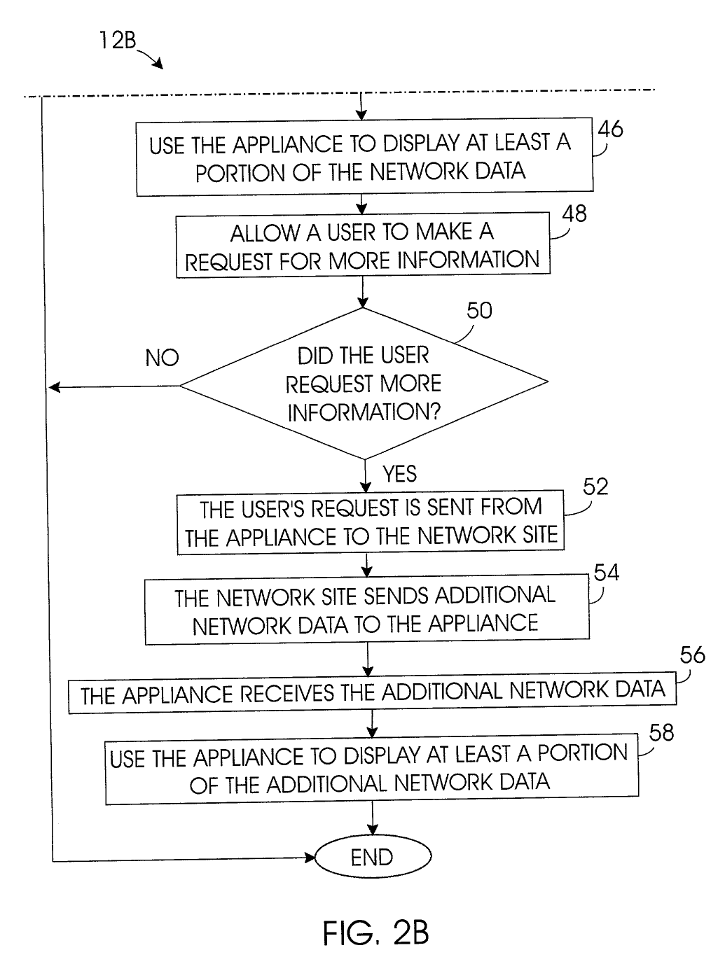

To carry out the various functional aspects of the invention, the apparatus 10 may be provided. Preferably, the apparatus 10 may be embodied in hardware, firmware and/or software (i.e., hardware and/or computer readable program code). For example, in one embodiment, the apparatus 10 may comprise computer readable program code and the necessary hardware for executing the same. The computer readable program code may be stored in one or more suitable computer readable storage media operatively associated with the network 24. For example, in a preferred embodiment, the computer readable program code comprising the apparatus 10 may be stored in one or more suitable computer readable storage media residing at, or associated with, the appliance 18. Alternatively, the computer readable program code comprising the apparatus 10 may be stored in one or more suitable computer readable storage media residing at, or associated with, the network site 20, the network device 30, elsewhere on the network 24, a combination thereof, etc. For example, the computer readable program code may be written in the Java programming language and be downloaded over the network 24 to the appliance 18 for execution thereat. The computer readable program code may also reside within a “hard wired” box or stand-alone device (not shown) that is operatively associated with the network 24 and the appliance 18. Regardless of where it resides, however, the computer readable program code may comprise program code for carrying out one or more of the various steps of the method 12 shown in FIG. 2 with such steps being performed automatically (i.e., without any user intervention), manually, or in some combination thereof.

According to one embodiment, the apparatus 10 may be operated in accordance with the method 12 shown in FIG. 2. In the first step 38 of method 12, the appliance 18 may be connected to the network 24, if it is not already so connected. As described in detail earlier, the appliance 18 is preferably enabled for connection to a Transmission Control Protocol/Internet Protocol (TCP/IP) network 24. However, the appliance 18 may also be connected to any suitable network or networks at step 38 via any suitable manner. Moreover, the appliance 18 may be linked directly to the network 24 (FIG. 1) or it may be linked to the network 24 via one or more intermediary devices (not shown).

In the next step 40, the network site 20 may be located on the network 24 so that the appliance 18 and the network site 20 may communicate with each other. Assuming that the appliance 18 remains in an idle or inactive mode, the network data 16 may be sent over the network 24 from the network site 20 to the appliance 18 at step 42. The appliance 18 may receive the network data 16 at step 44. In response, the appliance 18 may be used at step 46 (FIG. 2B) to display at least a portion 14 of the network data 16. In one embodiment, the at least a portion 14 of the network data 16 may be displayed on the display panel 22 of the appliance 18.

It should be noted that the appliance 18 may receive the network data 16 in its entirety before displaying any portion thereof at step 46. Alternatively, the appliance 18 may instead receive the network data 16 piecemeal or in portions. For example, the appliance 18 may receive and display the at least a portion 14 of the network data 16 at step 46 before the appliance 18 receives and displays any further portion of the network data 16.

It should also be noted that any of a wide range of formats and display modes may be used when displaying the at least a portion 14 of the network data 16. For example, the at least a portion 14 of the network data 16 may comprise a series of advertisements (e.g., banner advertisements, etc.) that scroll across the display panel 22, one after another. Alternatively, the at least a portion 14 of the network data 16 may comprise a series of advertisements that are individually displayed on the display panel 22 (e.g., pop-up ads, etc.), one after another. It is understood, however, that the at least a portion 14 of the network data 16 may also be displayed in any other suitable format as would be obvious to persons having ordinary skill in the art after having become familiar with the teachings of the present invention.

Once the at least a portion 14 of the network data 16 has been displayed on the display panel 22, the at least a portion 14 may be displayed for a given time interval that is set automatically (e.g., via computer readable program code, etc.), manually, in some combination thereof, etc. For example, if the at least a portion 14 of the network data 16 comprises a series of advertisements, each advertisement may be displayed for five seconds on the display panel 22. However, if the at least a portion 14 only comprises a single advertisement, that advertisement may be displayed until another advertisement is received at the appliance 18, or the appliance 18 is switched or returned to the active mode.

Regardless of the manner and the length of time that the at least a portion 14 of the network data 16 is displayed, the one or more functions implemented by the apparatus 10 should preferably not interfere with the regular course of operation for the appliance 18. Stated differently, the apparatus 10, or more specifically one or more of the functions it carries out, may be disabled or rendered inoperative when the appliance 18 is in an active mode (e.g., the appliance 18 is being used by a user, the sensor (not shown) located in the document feeder 32 senses that one or more documents are located within the document feeder 32, the appliance 18 is scanning documents, the appliance 18 is converting documents to electronic format, the appliance 18 is transmitting electronic documents, the start button or other key of keypad 36 is pressed, etc.). For example, if the appliance 18 is in the active mode, the network site 20 may stop sending network data to the appliance 18, the appliance 18 may refuse to or simply not receive network data sent from the network site 20, and/or the appliance 18 may receive network data but not display any portion thereof until the appliance 18 is back in an inactive or idle mode.

As shown in FIG. 2A, if it is determined that the appliance 18 is in an active mode at step 41, the network site 20 may not send (step 42) network data to the appliance 18. If it is determined that the appliance 18 is in an active mode at step 43, the appliance 18 may (step 44) refuse to or simply not receive network data sent from the network site 20. And, if it is determined that the appliance 18 is in an active mode at step 45, the appliance 18 may have received network data from the network site 20 but may not display any portion thereof (step 46) until the appliance 18 is back in an inactive or idle mode. By providing these features, the resources and/or components of the appliance 18 may thus be dedicated to the task for which the appliance 18 is currently being used.

After the appliance 18 has switched from the active mode to an inactive, idle, or standby mode, the apparatus 10 may be re-enabled or become operable again.

a By doing so, the apparatus 10 may be allowed to operate continuously during the inactive or idle periods of the appliance 18.

The method 12 may also include the step (step 48) of allowing a user to request more information from the network site 20. By providing this feature, the user may be able to obtain more thorough and detailed information than that which is provided by the at least a portion 14 of the network data 16. To make the request for more information, the user may be able to make a request (step 50), such as an email request, for the additional information by accessing the keypad 36 or display 22 of the appliance 18. More specifically, in one embodiment, the network site 20 may send computer readable program code in addition to the network data 16 to the appliance 18. The computer readable program code may be downloaded to the appliance 18 over the network 24 and may begin executing or operating on the appliance 18 when the user activates or selects a certain key (not shown) of keypad 36. The computer readable program code may provide data and/or information that allow the appliance 18 to create an email addressed to the network site 20 and requesting more information. The computer readable program code may also allow the user to specify the manner in which the user wishes to receive the additional information (e.g., via email, displayed via display panel 22, displayed via another network destination, via telephone, etc.). Stated differently, the computer readable program code may allow for a two-way interaction between the user and the network site 20. After the email request has been created, the appliance 18 may then send the email request (step 52) to the network site 20. The computer readable program code sent by the network site 20 to the appliance 18 may be written in the Java programming language, although other computer readable program languages are also possible.

Regardless of how the user makes the request more information, the method 12 may further comprise the network site 20 providing additional network data to the user that is based at least in part on the user's request for more information. For example, the network site 20 may send at step 54 the additional network data to the appliance 18. The appliance 18 may then receive at step 56 the additional network data. At step 58, the appliance 18 may be used to display at least a portion of the additional network data via display panel 22. Or for example, the appliance 18 may print at least a portion of the additional network data in those embodiments in which the appliance 18 comprises a printer apparatus (e.g., printer, multifunction peripheral, etc.). In another embodiment, the network site 20 and/or the appliance 18 may send the additional network data to one or more of the network devices (e.g., email account 26, fax 28, printer 29, etc.) for display thereby. For example, the network site 20 may send the additional network data directly to the email account 26 instead of sending it to the appliance 18. Or for example, the appliance 18 may, upon receipt of the additional network data, send the same to the email account 26 instead of displaying a portion of the additional network data.

Since the user may have more than one option available for displaying the additional network data, the method 12 may also comprise the optional step (not shown) of allowing the user to select the manner (e.g., scrolling display, pop-up display, etc.) and the device (e.g., appliance 18, email account 26, fax 28, printer 29, etc.) to be used for providing or displaying the at least a portion of the additional network data.

By allowing users to request additional information request, the invention may allow advertisers to reduce the size of and costs associated with their advertising costs. For example, since additional information may be requested by and provided to those interested consumers, an advertiser may opt to provide only a minimal amount of information in its ads thereby reducing the size of and costs associated with those ads.

This feature of the invention may also allow an advertiser to evaluate its ads and determine who is interested in its ads. For example, an advertiser may track its ads to determine which of its ads generated further inquiries and requests for more information and which did not. In response thereto, the advertiser may then take appropriate action (e.g., pulling unsuccessful ads, etc.).

Moreover, an additional proprietary or monetary gain may also be realized by providing the invention with this feature. For example, an advertiser may be charged an additional fee (e.g., a click fee) for each request for more information by a user. This fee may be in addition to the fees already charged to the advertiser for the right to have its ads displayed in accordance with the invention.

Preferably, the steps comprising method 12 are performed transparently and automatically (i.e., without any user intervention) to the user. Moreover, it is understood that FIG. 2, as is FIG. 1, is merely exemplary of the invention and is not intended to limit the scope thereof. In other embodiments, additional steps may be included in method 12 with such steps being performed automatically, manually, or in some combination thereof based on the configuration of the apparatus 10.

For example, the method 12 may comprise the additional step of allowing a user to select the network location that will send the network data 16. Such a selection may be made by the user keying in the web address or other identifier (e.g., uniform resource identifier(URI), uniform resource locator(URL), etc.)for the desired network location using the keypad 36 of appliance 18 or by selecting the same from a menu shown on the display panel 22 of appliance 18.

Although FIG. 1 shows the appliance 18 linked or connected to the network 24, such may not always be the case. Since the appliance 18 may not always be connected to the network 24, the network data 16 may be stored in one or more suitable computer readable storage media operatively associated with the appliance 18. By doing so, the appliance 18 may continue to display the network data 16 even if the appliance 18 is disconnected from the network 24 after receiving the network data 16.

As explained earlier, the apparatus 10, or more specifically one or more of the functions it carries out, may be disabled or rendered inoperable when the appliance 18 is in an active mode so as to not interfere with the regular course of operation for the appliance 18. However, it may also be desirable to provide a user with the ability to manually disable the apparatus 10 without regard for the mode of the appliance 18 (i.e., active or inactive). Thus, the method 12 may further include the step of allowing a user to disable the apparatus 10. More specifically, the apparatus 10 may further comprise an on/off switch (not shown) and computer readable program code for disabling and re-enabling the apparatus 10 in response to the on/off switch. In one embodiment, the user may be able to access the on/off switch by using the keypad 36 of appliance 18. In an alternative embodiment, the apparatus 10 may comprise a stand-alone device (not shown), and the on/off switch may comprise a mechanical switch provided on a housing of the stand-alone device.

It is to be understood that the computer readable program code described herein can be conventionally programmed using any of a wide range of suitable computer readable programming languages that are now known in the art or that may be developed in the future. It is also to be understood that the computer readable program code can include one or more functions, routines, subfunctions, and subroutines, and need not be combined in a single package but may instead be embodied in separate components. In addition, the program code can reside within the appliance 18 or it can have one or more components that reside at one or more locations on the network 24. Although it is envisioned that the invention disclosed herein will be implemented in software or firmware code, such need not be the case. That is, the invention may be implemented through hardware, firmware, etc., or a combination thereof.

What is claimed is:

1. A method for displaying network data, comprising:
receiving said network data at an appliance operatively associated with a network, said network data being from another device connected to the network;
displaying at least a portion of said network data on electronic display apparatus operatively associated with said appliance, said electronic display apparatus allowing for user interaction with and operation of said appliance; and
wherein electronically displaying data is not a primary function of said appliance.

2. The method of claim 1, wherein the at least a portion of said network data comprises an advertisement.

3. The method of claim 1, wherein the at least a portion of said network data comprises network textual data.

4. The method of claim 1, wherein the at least a portion of said network data comprises network graphical data.

5. The method of claim 1, wherein displaying at least a portion of said network data on electronic display apparatus operatively associated with said appliance comprises displaying the at least a portion of said network data on a display panel of said appliance.

6. The method of claim 1, further comprising:
allowing a user to request more information from said another device; and
providing additional network data to the user, said additional network data being from said another device and being based at least in part on the user's request for more information.

7. The method of claim 6, wherein providing additional network data to the user comprises printing at least a portion of said additional network data.

8. The method of claim 6, wherein providing additional network data to the user comprises receiving said additional network data at said appliance.

9. The method of claim 6, wherein providing additional network data to the user comprises displaying at least a portion of said additional network data on the electronic display apparatus operatively associated with said appliance.

10. The method of claim 6, wherein providing additional network data to the user comprises receiving said additional network data at an email account.

11. The method of claim 6, wherein allowing a user to request more information from said another device comprises allowing a user to email the request for more information to said another device.

12. The method of claim 1, further comprising determining whether said appliance is in an active mode, said appliance not receiving said network data from said another device if it is determined that said appliance is in the active mode.

13. The method of claim 1, further comprising determining whether said appliance is in an active mode, said electronic display apparatus not displaying the at least a portion of said network data if it is determined that said appliance is in the active mode.

14. The method of claim 1, wherein said appliance is physically linked to the network.

15. Apparatus for displaying network data, comprising:
one or more computer readable storage media; and
computer readable program code stored on said one or more computer readable storage media, said computer readable program code comprising:
program code for receiving said network data at an appliance operatively associated with a network, said network data being from another device connected to the network;
program code for displaying at least a portion of said network data on electronic display apparatus operatively associated with said appliance;
wherein said electronic display apparatus allows for user interaction with and operation of said appliance; and
wherein electronically displaying data is not a primary function of said appliance.

16. The apparatus of claim 15, wherein said computer readable program code further comprises:
program code for allowing a user to request more information from said another device; and
program code for providing additional network data to the user, said additional network data being from said another device and being based at least in part on the user's request for more information.

17. The apparatus of claim 16, said program code for allowing a user to request more information from said another device comprises program code for allowing a user to email the request for more information to said another device.

18. The apparatus of claim 15, wherein said computer readable program code further comprises:
program code for determining whether said appliance is in an active mode; and
program code for disabling said apparatus when it is determined that said appliance is in the active mode.

19. The apparatus of claim 15, wherein the at least a portion of said network data comprises an advertisement.

20. The apparatus of claim 15, wherein the at least a portion of said network data comprises network graphical data.

21. The apparatus of claim 15, wherein the at least a portion of said network data comprises network textual data.

22. The apparatus of claim 15, wherein said computer readable program code further comprises program code for allowing a user to disable said apparatus.

23. The apparatus of claim 15, wherein said appliance is physically linked to the network.

24. A multifunction device operatively associated with a network, comprising:
electronic display apparatus, said electronic display apparatus allowing for user interaction with and operation of said appliance;
one or more computer readable storage media;
computer readable program code stored on said one or more computer readable storage media, said computer readable program code comprising:
program code for receiving network data at said multifunction device, said network data being from another device connected to the network; and
program code for displaying at least a portion of said network data on said electronic display apparatus.

25. The multifunction device of claim 24, wherein said computer readable program code further comprises:
program code for allowing a user to request more information from said another device; and
program code for providing additional network data to the user, said additional network data being from said another device and being based at least in part on the user's request for more information.

26. Apparatus for displaying network data, comprising:
means for receiving said network data at an appliance operatively associated with a network, said network data being from another device connected to the network; and
means for displaying at least a portion of said network data received at said appliance.

27. A method for displaying network data, comprising:
receiving said network data at a multifunction device operatively associated with a network, said network data being from another device connected to the network; and
displaying at least a portion of said network data on a display panel of said multifunction device.

28. Apparatus for displaying network data, comprising:
one or more computer readable storage media; and
computer readable program code stored on said one or more computer readable storage media, said computer readable program code comprising:
program code for receiving said network data at a multifunction device operatively associated with a network, said network data being from another device connected to the network; and
program code for displaying at least a portion of said network data on a display panel of said multifunction device.

29. A method for displaying network data, comprising:
receiving said network data at an appliance operatively associated with a network, said network data being from another device connected to the network, said appliance having a paper-handling function associated therewith; and
displaying at least a portion of said network data on electronic display apparatus operatively associated with said appliance, said electronic display apparatus allowing for user interaction with and operation of said appliance.

30. The method of claim 29, wherein said appliance comprises scanner apparatus.

31. The method of claim 29, wherein said appliance comprises printer apparatus.
